(19) United States
(12) Patent Application Publication
(10) Pub. No.: US 2017/0070561 A1
(43) Pub. Date: Mar. 9, 2017

(54) Mechanism and Method for Constraint Based Fine-Grained Cloud Resource Controls

(71) Applicant: Futurewei Technologies, Inc., Plano, TX (US)

(72) Inventors: Li Li, Bridgewater, NJ (US); Tong Tang, Harrison, NJ (US); Wu Chou, Basking Ridge, NJ (US)

(21) Appl. No.: 14/846,528

(22) Filed: Sep. 4, 2015

(51) Int. Cl. H04L 29/08

(52) U.S. Cl. CPC H04L 67/10

(57) ABSTRACT

A method implemented in a network element (NE) configured to operate as a REST server, the method comprising receiving, through a receiver, a constraint from a REST client, wherein the constraint relates an independent control variable to a derived control variable, wherein the derived control variable is mapped to a first cloud computing resource employed by a cloud computing implementation; receiving, through the receiver, an independent value for the independent control variable from the REST client; computing, via a processor coupled to the receiver, a derived value for the derived control variable based on the constraint and the value for the independent control variable; determining, via a processor, a first instruction regarding the first cloud computing resource based on the derived value; and altering, via a resource controller coupled to the processor, one of a plurality of first behaviors of the first cloud computing resource based on the first instruction.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Cloud computing is a model for the delivery of hosted services, which may then be made available to users through, for example, the Internet. Cloud computing enables ubiquitous, convenient, on-demand network access to a shared pool of configurable fine-grained computing resources that can be provisioned and employed with minimal management effort or service provider interaction. By employing cloud computing resources, provisioners may deploy and manage emulations of particular computer systems through a network, which provide convenient access to the computing resources.

### SUMMARY

In one embodiment, the disclosure includes a network element (NE) configured to implement a representational state transfer (REST) system, the NE comprising a receiver configured to receive a constraint from a REST client, wherein the constraint relates an independent control variable to a derived control variable, wherein the derived control variable is mapped to a first cloud computing resource employed by a cloud computing implementation; and receive an independent value for the independent control variable from the REST client; and a processor coupled to the receiver and configured to compute a derived value for the derived control variable based on the constraint and the independent value for the independent control variable; and determine a first instruction regarding the first cloud computing resource based on the derived value.

In another embodiment, the disclosure includes a method implemented in a network element (NE) configured to operate as a REST server, the method comprising receiving, through a receiver, a constraint from a REST client, wherein the constraint relates an independent control variable to a derived control variable, wherein the derived control variable is mapped to a first cloud computing resource employed by a cloud computing implementation; receiving, through the receiver, an independent value for the independent control variable from the REST client; computing, via a processor coupled to the receiver, a derived value for the derived control variable based on the constraint and the value for the independent control variable; determining, via a processor, a first instruction regarding the first cloud computing resource based on the derived value; and altering, via a resource controller to the processor, one of a plurality of first behaviors of the first cloud computing resource based on the first instruction.

In yet another embodiment, the disclosure includes a computer program product comprising computer executable instructions stored on a non-transitory computer readable medium such that when executed by a processor cause a network element (NE) to receive, through a receiver, an independent value for an independent control variable; compute, via a processor, a derived value for a derived control variable based on a constraint and the independent value for the independent control variable, wherein the constraint relates the independent control variable to the derived control variable, wherein the derived control variable is mapped to a first cloud computing resource, wherein the first cloud computing resource is employed by a cloud computing implementation and provided to a recipient of the cloud computing implementation; and forward, through a transmitter coupled to the receiver, the derived value to a REST server implemented on another NE.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a REST system that comprises a REST client and one or more NEs.

FIG. 2 is a flowchart of an embodiment of a method employed by an NE in a REST system to build and employ a constraint map regarding an implementation of cloud computing resources.

FIG. 3 is a schematic diagram of an alternate embodiment of a REST system comprising a REST client 310 and two or more NEs.

FIG. 4 is a flowchart of an alternate embodiment of a method employed by an NE in a REST system to build and employ a constraint map regarding an implementation of cloud computing resources.

FIG. 5 is a schematic diagram of another embodiment of a REST system 500 comprising a REST client 510 and three or more NEs.

FIG. 6 is another embodiment of a flowchart of a method employed by a server in a REST system to build and employ a constraint map regarding an implementation of cloud computing resources.

FIG. 7 is a schematic diagram of an additional embodiment of an NE 700 within a REST system.

FIG. 8 is a protocol diagram of an embodiment of a protocol employed in a REST system between a REST client, a REST controller, and a constraint map server.

FIG. 9 is a Petri-Net diagram illustrating an embodiment of a constraint map that may be constructed and maintained by a constraint map server.

FIG. 10 is a flowchart of an exemplary embodiment employed by an NE in a REST system to build and employ a constraint map regarding an implementation of cloud computing resources.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

With a cloud computing solution, computing capabilities (e.g., fine-grained resources) are available over a network and may be elastically provisioned and released, in some cases automatically, to scale rapidly outward and inward commensurate with demand. A provider of cloud computing capabilities may pool fine-grained computing resources to serve multiple provisioners (e.g., service requestors) using a multi-tenant model where fine-grained resources may be dynamically assigned to a provisioner specified implementation and reassigned to other implementations according to consumer demand. Furthermore, providers may automatically control and optimize resource use by leveraging a metering capability at some level of abstraction appropriate to the type of resource (e.g., storage, processing, bandwidth, and active user accounts). In this manner, resource usage can be monitored, controlled, and reported, which provides transparency for both the provider and the provisioners of an employed implementation.

A cloud computing solution provides these resources without requiring provisioners to establish a computing infrastructure in order to service their consumers. Provisioners may provision the fine-grained resources in a specified implementation, thus allowing consumers to access the provisioned resources through mechanisms that promote use by heterogeneous thin or thick client platforms (e.g., mobile phones, tablets, laptops, and workstations). In multiple embodiments, consumers may be, for example, devises operated by users and or client applications. As such, provisioners may unilaterally provision computing capabilities, such as server time and network storage, as needed automatically without requiring human interaction with each service provider. To a provisioner, the computing capabilities available for provisioning may appear to be unlimited and can be appropriated in any quantity at any time. Generally, provisioners have little control or knowledge over the exact location of the provided resources but may be able to specify location at a higher level of abstraction (e.g., country, state, or datacenter).

In various embodiments, cloud computing services and resources may be provided to provisioners through a Resource-as-a-Service (RaaS) model. In such a RaaS model, a provider may continuously provide individual fine-grain resources for a determined period of time. In an embodiment, an implementation of cloud computing resources may have an operating system and application programs or other software for providing services, and may function as a computing environment. Additionally, the demand for resources imposed by a particular implementation built within a RaaS model may change over time due to, for example, varying load intensity from consumers. Within a RaaS model, static resource allocation may be inadequate as increases to load intensity may lead to resource exhaustion and/or service interruption, while a decrease in demand may lead to resource waste. Dynamic resizing of allocated resources, however, provides additional computing resources when needed, thus allowing computing resources to be consumed as needed by an implementation and released at other times for use by other implementations.

Representational state transfer (REST) is an architectural style that may include a coordinated set of architectural constraints applied to components, connectors, and data elements for building scalable web services such as those employed by in cloud computing solution. REST ignores the details of component implementation and protocol syntax in order to focus on the roles of components, the constraints upon their interaction with other components, and their interpretation of significant data elements. The REST architectural style may be applied to the development of web services as an alternative to other distributed-computing specifications such as, for example, Simple Object Access protocol (SOAP). One can characterize web services as “RESTful” if they conform to certain architectural constraints involving or relating to a client-server model, a stateless protocol, a web cache, a layered system, code on demand (optional), and a uniform interface. In some circumstances, the REST architectural style may be applied to web application programming interfaces (APIs). Web APIs that adhere to the architectural constraints are called RESTful.

Disclosed herein are various mechanisms for dynamic scalability of cloud computing resources in a REST system through the employment of dual control constraint maps (constraint map). In various embodiments, constraint maps provide both a language and a mechanism to define constraints and apply the constraints to cloud computing resources employed in various provisioner specified implementations. As discussed below, provisioners may provision and combine fine-grained cloud computing resources as an implementation. Examples of fine-grained cloud computing resources include network bandwidth, storage, processing, Input/Output (I/O), applications, and/or services. Control variables may be mapped to the various resources employed to control the behavior of the resources in the implementation. In various embodiments, the control variables for a particular implementation are related to each other through constraints. Each constraint defines a relationship between control variables (e.g., resources) provisioned to an implementation. In various embodiments, constraints are combined in one or more constraint maps that are employed by the REST system to govern relationships between the set of resources for a particular implementation. As consumers interact with various resources provided by an implementation, the REST system determines behaviors for the various resources based on dynamically determining values for the control variables and through the application of the specified constraints.

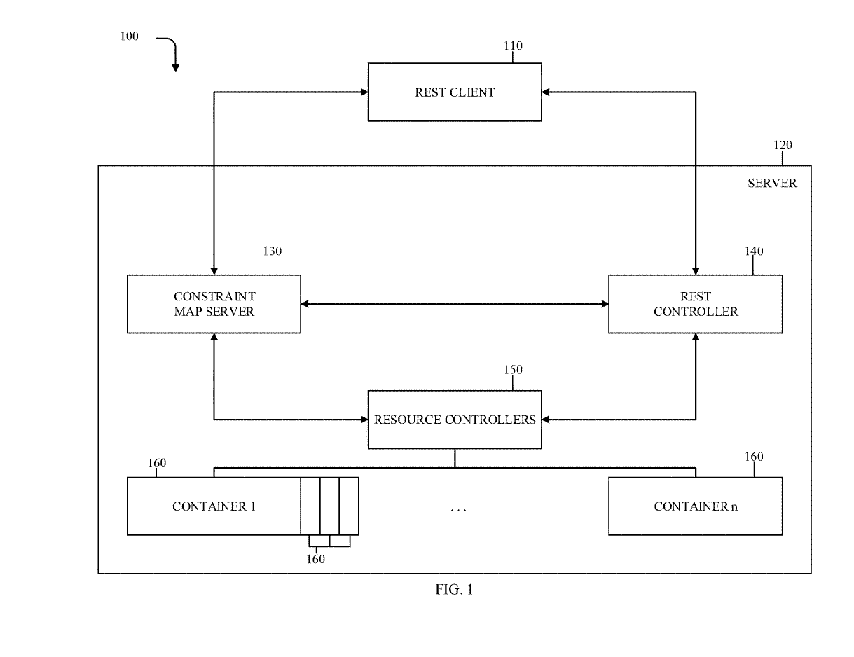

FIG. 1 is a schematic diagram of a REST system 100 that comprises a REST client 110 and one or more network elements (NEs) (e.g., computing devices and/or server cluster), which for convenience will be referred to herein as server 120. Provisioners may provision and combine fine-grained cloud computing resources served via the containers 160 as an implementation. Control variables may be mapped to the various resources employed as the implementation. Each control variable contains a value that the REST system 100 employs to determine the behavior of a mapped resource provided through containers 160. In various embodiments, control variables may be directly altered (independent control variable) by, for example, REST client 110 or indirectly derived (derived control variable) via the employment of various constraints by, for example, server 120. In various embodiments, a control variable may serve as both an independent control variable and a derived control variable. For example, a value for a control variable for a given implementation may be altered directly and thus serve as an independent control variable or may also be indirectly altered based on a change to the value of another control variable(s) related through a constraint.

In various embodiments, an implementation of cloud computing resources comprises containers that are hosted on a server(s). These containers may then be coupled to provide a multiple server architecture solution where each container functions in a particular role. For example, a container may function as a webserver, database server, application server, etc. Containers 160 on server 120 are allocated related hardware resources available via server 120 that can be employed to implement various functions on an as needed basis. For example, resources allocated to the containers 160 may be combined to serve as one of a plurality of servers (e.g., as a webserver) and other resources allocated to the containers 160 may be employed to serve as another one of the plurality of servers (e.g., as an application server). Constraints governing the relationship between these resources may be combined in one constraint map or they may be combined in more than one constraint map. As an example, constraints governing the resources of containers 160 allocated as a webserver may be placed in a constraint map and constraints governing the resources of containers 160 allocated as an application server may be placed in another constraint map. Additionally, behaviors of a resource employed by one container may be governed based on the value of a derived control variable. The value for the derived variable may be determined through a constraint that correlates the value of the derived control variable to a control variable (either independent or derived) that is mapped to a resource employed by another container. To state another way, behavior of resources employed by one container in an implementation may be controlled, indirectly, by changes to behaviors of resources employed by another container in the implementation.

In various embodiments, the REST client 110 is a component that may be implemented in a network apparatus or module such as, for example, personal computer (PC) or a mobile device (e.g., smart phone, tablet computer, etc.). The features and/or methods implemented by REST client 110 may be realized using hardware, firmware, and/or software installed on the network apparatus or module. The REST client 110 may include one or more APIs employed to implement a web application. The REST client 110 may be an application specific integration, such as a user agent, an automation, or a workflow engine.

Server 120 comprises a constraint map server 130, a REST controller 140, resource controllers 150, and containers 160, which are components implemented using hardware, firmware, and/or software and installed on the server 120. In some embodiments, the constraint map server 130, REST controller 140, resource controllers 150, and containers 160 are implemented through server clusters. In various embodiments, the constraint map server 130 and the REST controller 140 are implemented via a REST API. The REST client 110 may communicate to the constraint map server 130 and/or the REST controller 140 via a connection established through the server 120. Resource controllers 150 may be implemented on the same server as either the constraint map server 130 or the REST controller 140 or on a different server. In various embodiments, resource controllers 150 are configured to serve as bus arbiters on server 120. For example, resource controllers 150 may be employed to determine which bus master implemented on server 120 will be allowed to control a particular bus on server 120 for each bus cycle. In some embodiments, the resource controllers 150 are LINUX® controllers. In various embodiments, the resource controllers 150 control and distribute information to a plurality (1-n) of containers 160. In various embodiments, containers 160 abstract the server operating system kernel, run processes of server 120 in isolation, and do not require or include a separate operating system. In various embodiments, containers 160 are Docker containers, which may run in a single LINUX instance.

In various embodiments, the constraint map server 130 maintains a constraint map. Each constraint map comprises a set of constraints associated with an implementation of cloud computing resources. The constraints may be specified through, for example, REST client 110 by provisioners of the cloud computing resources provided via resource controllers 150. In some embodiments, the constraints are described via mathematical functions and/or formulas. The employment of constraint maps provides a mechanism for a REST system 100 to alter various derived control variables based on values specified or derived for other control variables. In such embodiments, a control variable may be altered directly (e.g., independent control variable) by a provisioner through, for example, REST client 110 or by various components of the REST system 100 (e.g., constraint map server 130, REST controller 140, resource controllers 150, etc.). In this manner, a REST system 100 may control all resources for a given implementation through the direct manipulation of a subset of a total number of control variables (e.g., the independent control variable) specified for the implementation. In an embodiment, the constraints are built and maintained by provisioners of the cloud computing resources through an API.

The constraint map server 130 accepts the constraints for an implementation of cloud computing resources from the REST client 110. Behaviors of the resources allocated to the containers 160 (e.g., processing, memory, storage, and/or network) employed by the implementation may be modified by the constraint net server 130 through the resource controllers 150 based on a value for the control variables. The control variables values may be altered based on the constraints that associate the control variable with one another. In an embodiment, the REST controller 140 accepts requests from the REST client 110 to control, through the resource controllers 150, resources allocated to the containers 160.

The disclosed solution allows an implementation to exhibit a preference for particular resources because an implementation of cloud computing resources may employ the resources in a specified manner (e.g., as specified via REST client 110). In this manner, the usage of resources are not random but rather determined by how the implementation employs cloud computing resources and how these resources are related to each other through the constraint map(s) specified for the implementation. For example, in one embodiment an implementation may be described as central processing unit (CPU) intensive, I/O intensive, and/or memory intensive, where each is described by a particular resource the implementation employs most heavily. In an embodiment, provisioners may trade or share the provisioned resources with each other.

In some embodiments, some control variables, such as link bandwidth, may not be directly accessible to provisioners (e.g., derived control variables) and thus may be set based on other control variables such as, for example, maximum allowed delay, jitter and packet loss. Delay is the time taken from point-to-point in a network and may be measured in either one-way or round-trip delay. In an embodiment, in order to obtain a general measurement of one-way delay, a measure of a round-trip delay is divided by two. Jitter is the variation in delay over time from point-to-point. The amount of jitter tolerable on the network is affected by the depth of the jitter buffer on the network equipment in the voice path. The more jitter buffer available, the more the network can reduce the effects of jitter. Packet loss is a measurement of losing packets lost along the data path. In various embodiments, constraints maintain preferred resource combinations, which reduce the amount of independent control variables for a given implementation. Thus, a change to one control variable may affect other control variables proportionately through the manipulation of the values of derived control variables.

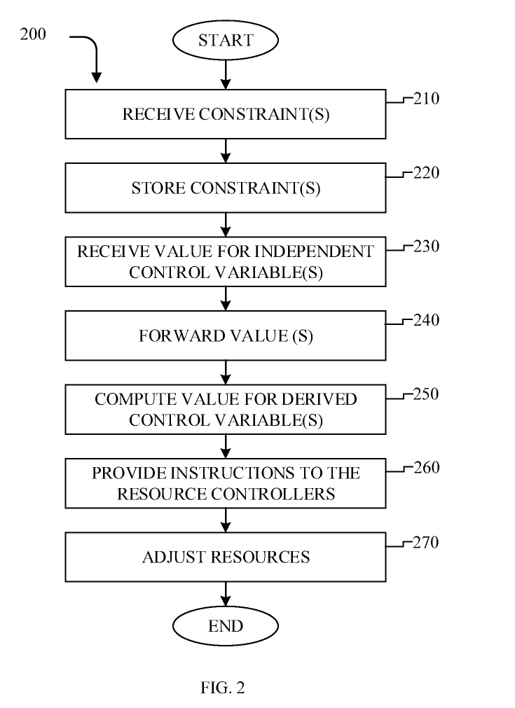

FIG. 2 is a flowchart of a method 200 employed by an NE, such as server 120, in a REST system, such as REST system 100, to build and employ a constraint map regarding an implementation of cloud computing resources. Method 200 may be implemented when a component, such as constraint map server 130, implemented on the server receives a constraint(s) regarding an implementation of cloud computing resources from a REST client, such as REST client 110. At step 210 a constraint map server, such as constraint map server 130, implemented in the server receives a constraint(s) regarding an implementation of cloud computing resources from a REST client. At step 220 the constraint map server stores the received constraint(s). At step 230, a REST controller, such as REST controller 140, implemented in the server receives a value(s) for an independent control variable(s) from the REST client. The independent control variable(s) is mapped to a resource(s) allocated to a container(s), such as containers 160, wherein the resource(s) is made available for allocation by the server. At step 240, the REST controller forwards the received value(s) for the independent control variable(s) to the constraint map server and the resource controllers, such as resource controllers 150, implemented in the server. At step 250, the constraint map server computes value(s) for derived control variable(s) based on the constraint map and the values received for the independent control variable(s). At step 260, the constraint map server provides instructions to the resource controllers regarding the resources employed by the cloud computing implementation based on the values for the control variables (both independent and derived). In an alternate embodiment at step 260, the constraint map servers forwards the values(s) for the derived control variables to the REST controller and the REST controller then provides instructions to the resource controllers regarding the resources employed by the cloud computing implementation based on the values for the control variables (both independent and derived). At step 270, the resource controllers adjust resources corresponding to the control variables (both independent and derived) based on the instructions received at step 260.

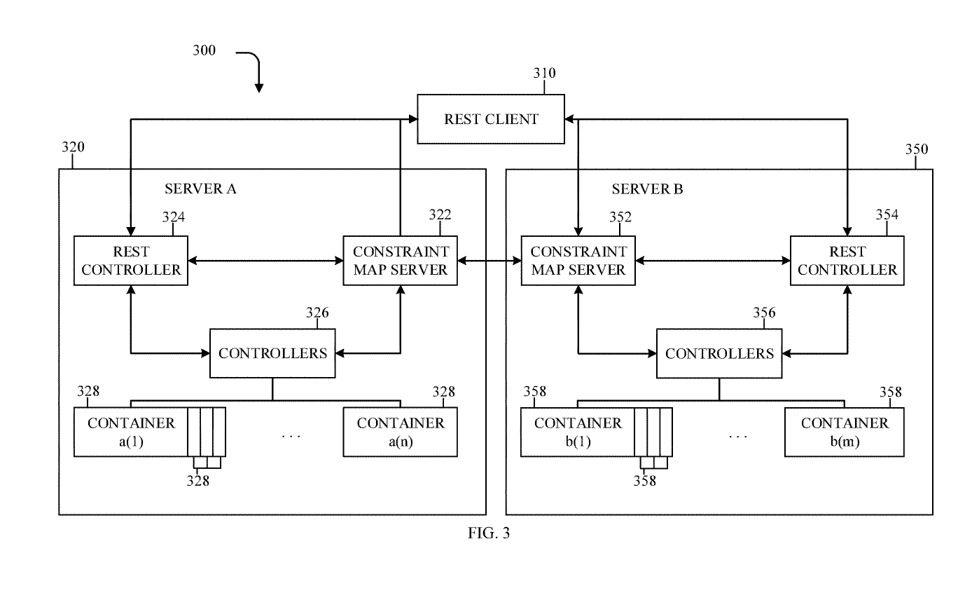

FIG. 3 is a schematic diagram of an alternate embodiment of a REST system 300 comprising a REST client 310 and two or more NEs, which for convenience will be referred to herein as server A 320 and server B 350. REST client 310 is substantially similar to REST client 110. Server A 320 and sever B 350 are substantially similar to server 120. The constraint map server 322 and/or the REST controller 324 may be implemented on the server A 320. The constraint map server 352 and/or the REST controller 354 may be implemented on server B 350. The constraint map servers 322 and 352 are substantially similar to constraint map server 130. The REST controllers 324 and 354 are substantially similar to REST controller 140. Unlike REST system 100, the constraint map server 322 and the constraint map server 352 may communicate via a connection established between server A 320 and server B 350. The resource controllers 326 may control and distribute information to a plurality (1-n) of containers a 328. The resource controllers 356 may control and distribute information to a plurality (1-m) of containers b 358. The resource controllers 326 and 356 are substantially similar to resource controllers 150. The containers a 328 and b 358 are substantially similar to containers 160.

Unlike REST system 100, resources allocated to a set of containers, such as containers a 328 and/or containers b 358, implemented on a server, such as server A 320, may be employed to serve as one of a plurality of servers (e.g., as a webserver) and resources allocated to a different set of containers, such as containers b 358, implemented on a different server, such as server B 350, may be employed to serve as another one of the plurality of servers (e.g., as an application server). In some embodiments, the constraint maps contained in a constraint map server may be unique from other constraint maps contained in other constraint map servers. In various embodiments, a constraint map server may distribute values of the independent and derived control variables to other constraint map servers implemented on other servers. In this manner, control variables governing resources allocated to a given implementation that are provided via multiple servers, such as server A 320 or server B 350, may be correlated.

As an example, a set of first resources may be employed as a webserver for an implementation and a set of second resources may be employed as an application server for the implementation. In this example, the webserver may require additional processing and processing has been mapped to an independent control variable on server A 320. The REST client 310 communicates the need for additional processing to server A 320. The resources allocated for the webserver are updated according to a first constraint map corresponding to the webserver. The first constraint map is contained in a first constraint map server, such as constraint map server 322. In this example the first constraint map server communicates values for any independent and derived control variables updated in response to the request for additional processing to a second constraint map server, such as constraint map server 352. In this example, the second constraint map server governs the set of second resources for the application server. The second constraint map server may then update values for the control variables mapped to the second set of resources based on a second constraint map and the values for the control variables received from the first control net server. The containers, such as containers b 358, may then alter the behavior of the set of second resources based on the updated values. In this example, the first and second constraint maps may be unique but correlated by, for example, a mapping or a table. Thus, the first and second constraint maps may link resource allocation across servers for a given implementation.

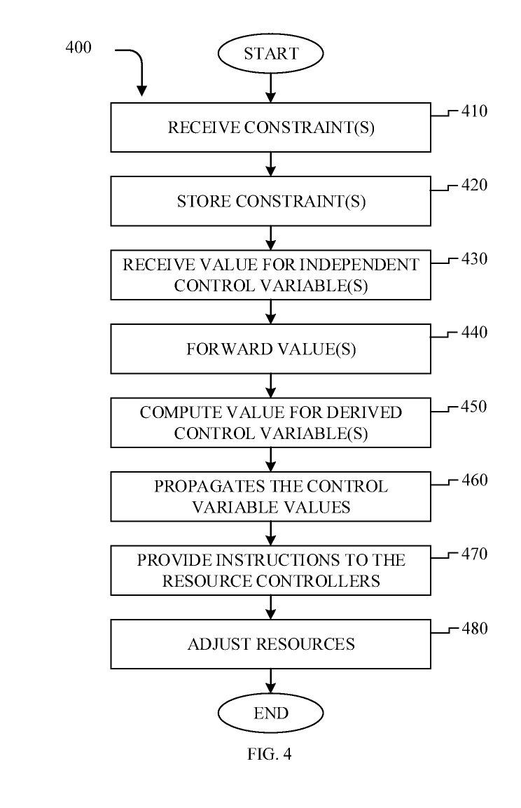

FIG. 4 is a flowchart of an alternate embodiment a method 400 employed by an NE, such as server A 320 or server B 350, in a REST system, such as REST system 300, to build and employ a constraint map regarding an implementation of cloud computing resources. Method 400 may be implemented when a component, such as constraint map server 322 or 352, implemented on the server receives a constraint(s) regarding an implementation of cloud computing resources from a REST client, such as REST client 310. At step 410 a constraint map server implemented in the server receives a constraint(s) regarding an implementation of cloud computing resources from a REST client. At step 420 the constraint map server stores the received constraint(s). At step 430, a REST controller, such as REST controller 324 or 354, implemented in the server receives a value(s) for an independent control variable(s) to control a resource(s) from the REST client. The independent control variable(s) is mapped to a resource(s) implemented in a container(s), such as containers a 328 or containers b 358, wherein the resource(s) is employed by the implementation of cloud computing resources. At step 440, the REST controller forwards the received value(s) for the independent control variable(s) to the constraint map server and the resource controllers, such as resource controllers 326 or 356, implemented in the server. At step 450, the constraint map server computes value(s) for derived control variable(s) based on the constraint map and the values received for the independent control variable(s). At step 460, the constraint map server propagates the value(s) for the control variable(s) (both derived and independent) to any other constraint map server employed on servers, such as server A 320 and/or server B 350, associated with the implementation of the cloud computing resources. At step 470, the constraint map server provides instructions to the resource controllers regarding the resources employed by the cloud computing implementation based on the values for the control variables (both independent and derived). In an alternate embodiment at step 470, the constraint map server forwards the derived control variables to the REST controller and the REST controller then provides instructions to the resource controllers regarding the resources employed by the cloud computing implementation based on the values for the control variables (both independent and derived). At step 480, the resource controllers adjusts resources corresponding to the control variables (both independent and derived) based on the instructions received at step 470.

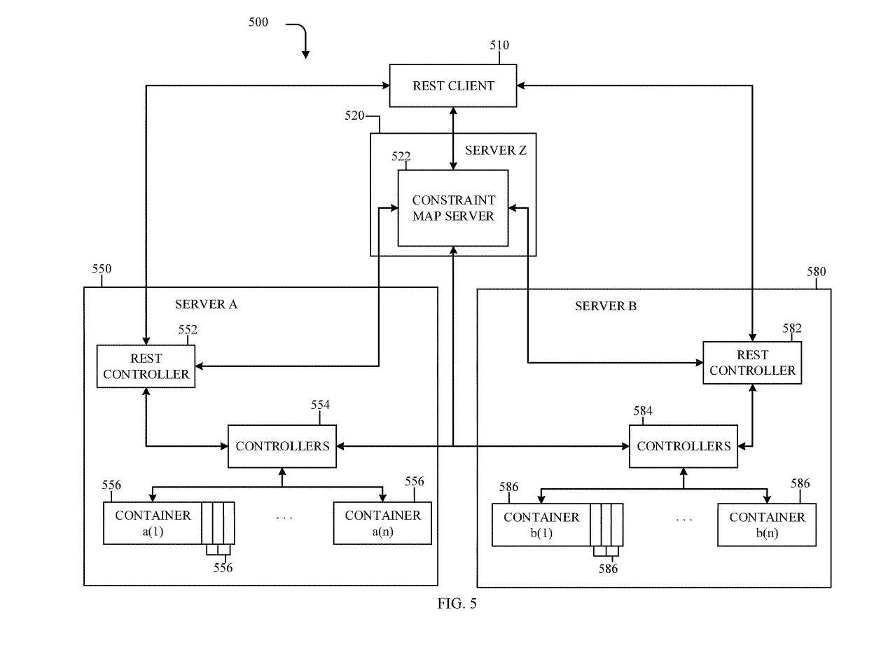

FIG. 5 is a schematic diagram of another embodiment of a REST system 500 comprising a REST client 510 and three or more NEs, which for convenience will be referred to herein as server Z 520, server A 550, and server B 580. REST client 510 is substantially similar to REST client 110. Constraint map server 522 is implemented on server Z 520. In the disclosed embodiment, two servers (server A 550 and server B 580) are shown implementing a REST controller (REST controller 552 and REST controller 582), resource controllers (resource controllers 554 and controllers 584), and containers (containers a 556 and containers b 586). It should be understood that any numbers of servers may be employed that implement the above stated components. Server A 550 and server B 580 are substantially similar to server 120 though, unlike REST system 100, the constrain net server 522 is not implemented on the same server as either REST controller 552 or 582. The resource controllers 326 and 356 are substantially similar to resource controllers 150. The containers a 338 and b 358 are substantially similar to containers 160. Unlike REST system 100, the REST client 510 may communicate to the constraint map server 522 via a connection established through the server Z 520. The REST client 510 may communicate the constraint(s) to the REST controllers 552 and 582 via connections established through the server A 550 and server B 580 respectively.

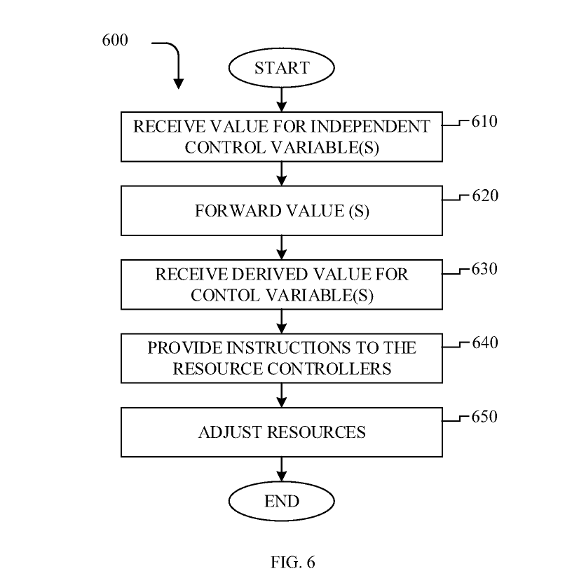

FIG. 6 is a flowchart of another embodiment of a method 600 employed by a server, such as server A 550 or server B 580, in a REST system, such as REST system 500, to build and employ a constraint map regarding an implementation of cloud computing resources. Method 600 may be implemented when a component, such as REST controllers 552 or 582, implemented on the server receives a value(s) for an independent control variable(s) regarding an implementation of cloud computing resources from a REST client, such as REST client 510. At step 610, a REST controller, such as REST controllers 552 or 582, implemented in the server receives a value(s) for an independent control variable(s) from the REST client 510. The independent control variable(s) is mapped to a resource(s) allocated to a container(s), such as containers a 556 or containers b 586, wherein the resource(s) is employed by an implementation of cloud computing resources. At step 620, the REST controller forwards the received value(s) for the independent control variable(s) to the constraint map server 522 and the resource controllers, such as resource controllers 554 or 584, implemented in the server. At step 630, the REST controller receives a value(s) for a derived control variable(s) from the constraint map server 522, wherein the value(s) for the derived control variable is determined based on the value(s) for the independent control variable(s) provided by the REST client and a constraint map regarding the employment of resources for the implementation of cloud computing resources. At step 640, the REST controller provides instructions to the resource controllers regarding the resources employed by the cloud computing implementation based on the values for the control variables (both independent and derived). At step 650, the resource controllers adjust resources corresponding to the control variables (both independent and derived) based on the instructions received at step 640.

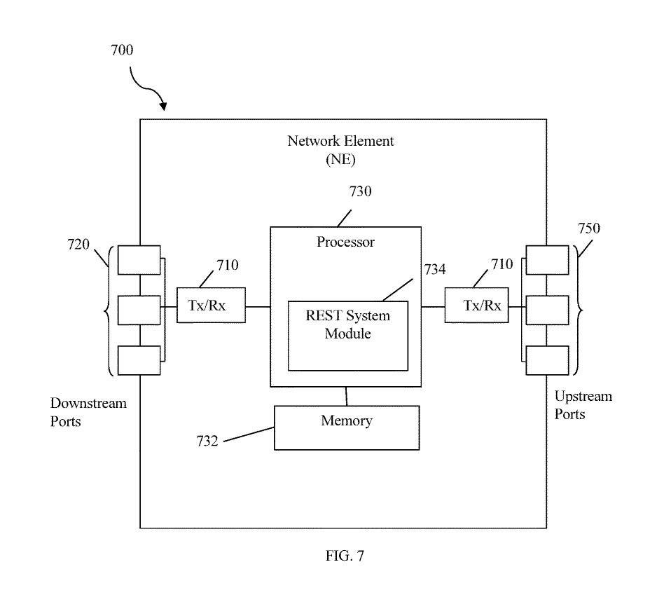

FIG. 7 is a schematic diagram of additional embodiment of an NE 700 within a REST system, such REST system 100, 300, or 500. NE 200 may be any component configured to act as server, such as server 120, server A 320, server B 350, server Z 520, server A 550, or server B 580, or configured to run a REST client, such as REST client 110, 310, or 510. NE 700 may be implemented in a single node or the functionality of NE 700 may be implemented in a plurality of nodes. One skilled in the art will recognize that the term NE encompasses a broad range of devices of which NE 700 is merely an example. NE 700 is included for purposes of clarity of discussion, but is in no way meant to limit the application of the present disclosure to a particular NE embodiment or class of NE embodiments.

At least some of the features/methods described in the disclosure are implemented in a network apparatus or component such as an NE 700. For instance, the features/methods in the disclosure may be implemented using hardware, firmware, and/or software installed to run on hardware. The NE 700 is any device that transports packets through a network, e.g., a switch, router, bridge, server, a client, etc.

As shown in FIG. 7, the NE 700 may comprise transceivers (Tx/Rx) 710, which are transmitters, receivers, or combinations thereof. A Tx/Rx 710 is coupled to a plurality of downstream ports 720 (e.g., downstream interfaces) for transmitting and/or receiving packets from other nodes and a Tx/Rx 710 is coupled to a plurality of upstream ports 750 (e.g., upstream interfaces) for transmitting and/or receiving packets from other nodes, respectively. A processor 730 is coupled to the Tx/Rxs 710 to process the packets and/or determine to which nodes to send packets. The processor 730 may comprise one or more multi-core processors and/or memory 732 devices, which function as data stores, buffers, Random Access Memory (RAM), Read Only Memory (ROM), etc. Processor 730 may be implemented as a general processor or may be part of one or more application specific integrated circuits (ASICs) and/or digital signal processors (DSPs). Processor 730 comprises a REST System Module 734, which implements at least some of the methods discussed herein such methods 200, 400, 600, and/or 1000 described below. In an alternative embodiment, REST System Module 734 is implemented as instructions stored in memory 732, which are executed by processor 730, or implemented in part in the processor 730 and in part in the memory 732, for example a computer program product stored in a non-transitory memory that comprises instructions that are implemented by the processor 730. In another alternative embodiment, the REST System Module 734 is implemented on separate NEs. The downstream ports 720 and/or upstream ports 750 may contain electrical and/or optical transmitting and/or receiving components.

It is understood that by programming and/or loading executable instructions onto the NE 200, at least one of the processor 730, REST System Module 234, Tx/Rxs 210, memory 732, downstream ports 720, and/or upstream ports 750 are changed, transforming the NE 700 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design is developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

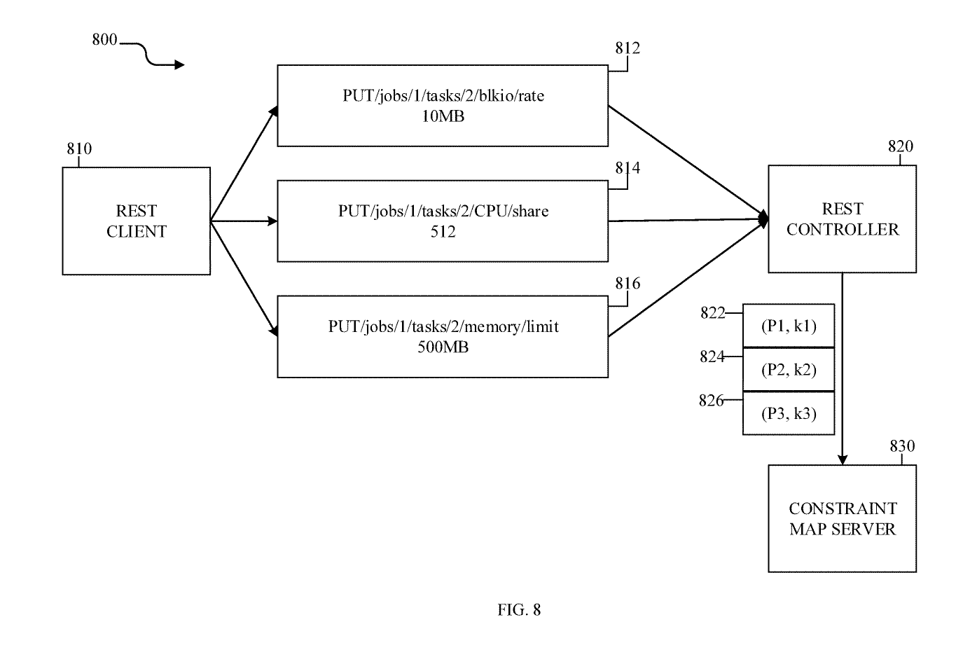

FIG. 8 is a protocol diagram of an embodiment 800 of a protocol employed in a REST system, such as REST system 100, 300, or 500, between a REST client 810, such as REST client 110, 310, or 510; a REST controller 820, such as REST controllers 140, 324, 354, 552 or 582; and a constraint map server 830, such as constraint map servers 130, 322, 352, or 522. REST client 810 may send control variables and values to the REST controller 820 in a manner such as described by 812, 814, and 816, which employ a specified protocol. In an embodiment, the protocol is an Hypertext Transfer Protocol (HTTP) where a first element indicates a variable name or location and a second value indicates a value for the first element. As an example, the variables and values may be sent as “PUT/jobs/1/tasks/2/blkio/rate, 10 MB”, “PUT/jobs/1/tasks/2/CPU/share, 512”, “PUT/jobs/1/tasks/2/memory/limit, 500 MB”. The REST controller may translate and send the control variables to the constraint map server 830 using an asynchronous protocol, such as Java Message Service (JMS) or a synchronous protocol, such as HTTP. In an example, the control variables are sent as in the form of (variable name, value). In one example the control variables are sent as (P1, k1) 822 where P1 is set to “PUT/jobs/1/tasks/2/blkio/rate” and k1 is set to “10 MB”; (P2, k2) 824 where P2 is set to “PUT/jobs/1/tasks/2/CPU/share” and k2 is set to “512”; and (P3, k3) 826 where P3 is set to “PUT/jobs/1/tasks/2/memory/limit” and k3 is set to “500 MB”. In the preceding examples each control variable is identified by a uniform resource identifier (URI) in the protocol.

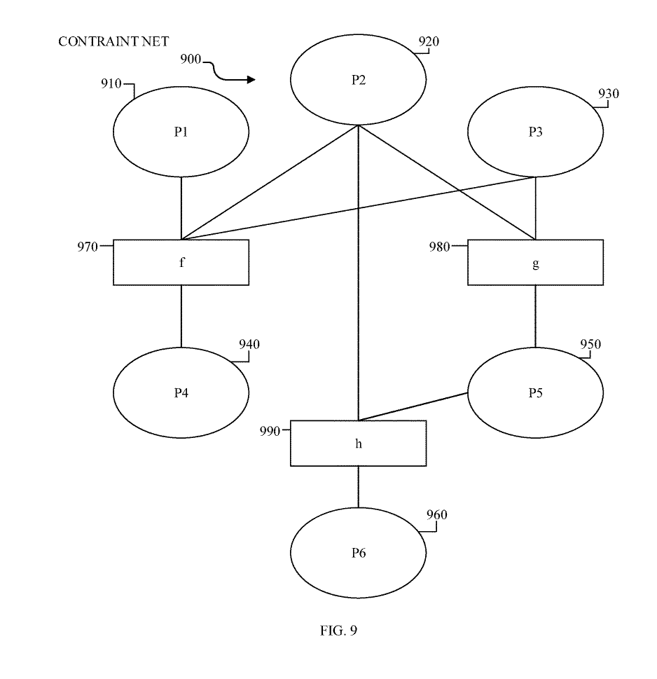

FIG. 9 is a Petri-Net diagram illustrating an embodiment of a constraint map 900 (e.g., constraint map) that may be constructed and maintained by a constraint map server, such as constraint map servers 130, 322, 352, or 522. Petri-Net is a mathematical modeling language used for the description of distributed systems. It is understood that the use Petri-Net to represent the constraint map is one of many mathematical modeling languages that may be employed. In various embodiments, control variables are specified for each cloud computing resource. A constraint map provides both a language and a mechanism to define the constraints and have the constraints applied to the set of resources provided through containers, such as containers 160. The constraint map may comprise a set of constraints associated with an implementation of cloud computing resources. In various embodiments, each set of constraints contained within a constraint map defines the relationship between resources (e.g., the control variables) through mathematical functions for a particular implementation of cloud computing resources. In an embodiment, the constraints are established by the provisioners of the cloud computing resources through an API that allows the provisioners to construct a constraint map for a particular implementation of cloud computing resources.

In the disclosed embodiment in FIG. 9, a place (oval) represents a control variable that is an input to various functions and a transition (rectangle) with n number of places represents n functions each of which maps a set of n-1 places to the n-th place. To state another way, a place stores control variables and a transition stores functions that relates the control variables.

In the disclosed embodiment in FIG. 9, a place has a timestamp to record the time the token (e.g., value) is deposited. A token may not be removed when a transition fires. The disclosed embodiment 900 relates the control variables defined via the constraint equations which are represented in the transitions f 970, g 980, and h 990. A value for each place, P1-P6 (910-960), may be computed from either the constraints defined by f 970, g 980, or h 990 or set by some external control without having to replace a current value first. In the disclosed embodiment, a value for P4 940 may be determined based on f 970 which is equated from the values set for P1 910, P2 920, and P3 930. In the disclosed embodiment, a value for P5 950 may be determined based on g 980 which is equated from the values set for P2 920 and P3 930. In the disclosed embodiment, a value for P6 960 may be determined based on h 990 which is equated from the values set for P2 920 and P5 950. A value for a place, 910-960, may be computed (e.g., a derived control variable) by an associated transition (e.g., equation) or it may be set directly (e.g., an independent control variable). Timestamps are employed to resolve any conflicts between values (e.g., a current value for a place is determined by the latest timestamp of a set value or a determined value through a transition).

In an example, the equation for the transition may be specified as f 970=P1 910+P2 920+P3 930, g 980=P2 920+P3 930 and h 990=P2 920−P5 950. At a time t1, P1 910 is set to a value of 1, P2 920 is set to a value of 2, and P3 930 is set to a value of 3. At time t2, transition f 970 may calculate a value for P4 940 as 6 (P1 910 (1)+P2 920 (2)+P3 930 (3)=6). At time t3, transition g 980 may calculate a value for P5 950 as 5 (P2 920 (2)+P3 930 (3)=5). At time t4, transition h 990 may calculate a value for P6 960 as 3 (P5 950 (5)−P2 920(2)=3). In this example, t4>t3, t2>t1, and t3>t1.

In another example, the equation for the transition may be specified as f 970=P1 910+P2 920 +P3 930, g 980=P2 920+P3 930 and h 990=P2 920−P5 950 (same as above). At a time t0, P1 910 is set to a value of 1, P2 920 is set to a value of 2, P3 930 is set to a value of 3, P4 940 is set to a value of 4, P5 950 is set to a value of 5, and P6 960 is set to a value of 6. At time t1, P3 930 is set to 5. At time t2, P5 950 is set to 6. At time t2, transition f 970 may calculate a value for P4 940 as 9 (P1 910 (1)+P2 920 (5)+P3 930 (3)=9). At time t3, transition h 990 may calculate a value for P6 960 as 1 (P5 950 (6)−P2 920 (5)=1). In this example, t3>t2>>t1>t0. In this example, the value for P5 950 is not overwritten by the value calculated from transition g 980 because time t2 is greater than t1.

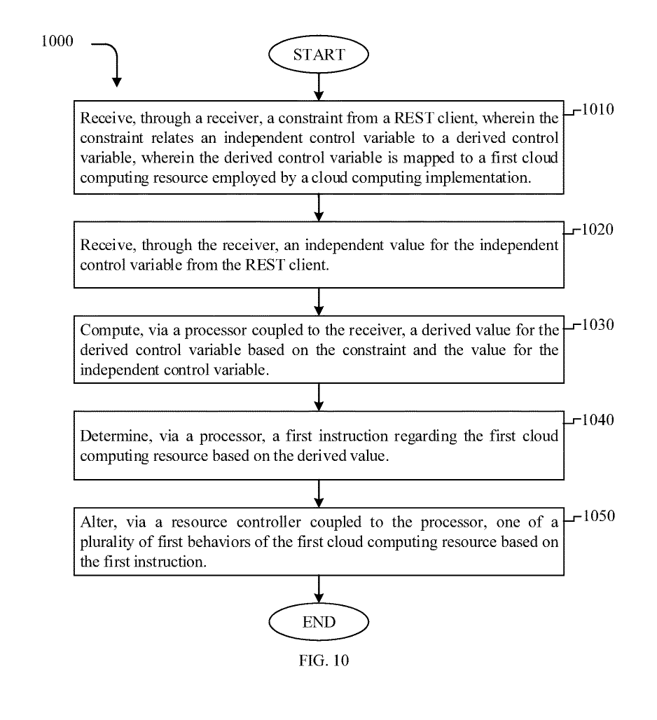

FIG. 10 is a flowchart of an exemplary embodiment employed by an NE, such as server 120, server A 320, server B 350, server Z 520, server A 550, or server B 580, in a REST system, such as REST system 100, 300, or 500, to build and employ a constraint map regarding an implementation of cloud computing resources. At step 1010, the server receives, through a receiver, a constraint from a REST client, wherein the constraint relates an independent control variable to a derived control variable, wherein the derived control variable is mapped to a first cloud computing resource employed by a cloud computing implementation. At step 1020, the server receives, through the receiver, an independent value for the independent control variable from the REST client. At step 1030, the server computes, via a processor coupled to the receiver, a derived value for the derived control variable based on the constraint and the value for the independent control variable. At step 1040, the server determines, via a processor, a first instruction regarding the first cloud computing resource based on the derived value. At step 1050, the server alters, via a resource controller coupled to the processor, one of a plurality of first behaviors of the first cloud computing resource based on the first instruction.

In an embodiment the constraint map operation procedures are specified as:

```
Net.run_auto(queue)
    while not Net.stop
      requests = deque_all(queue)
      ts = time( )
      for each P in Net.places
        P.timestamp = ts
      end
      ts = time( )
      for each req in requests
        Net.places(req.place).deposit(req.token, ts)
      end
      Net.fire_transitions( )
    end
end
Net.fire_transitions( )
  fire = true
  while fire do
      fire = false
      for each T in Net.transitions
        if T.is_enabled( ) then
          T.fire( )
          fire = true
        end
    end
  end
end
P.deposit(token, ts)
    If token ≠ P.token then
        P.token = token
        P. timestamp = ts
    end
end
T.fire( ):
    function = T.select_function( )
    token = function([P.token|P in T.input_places])
    T.output_place.deposit(token, time( ))
end
T.fire( ):
    function = T.select_function( )
    token = function([P.token|P in T.input_places])
    T.output_place.deposit(token, time( ))
end
T.is_enabled( )
  tin = max([P.timestamp|P in T.input_places])
  tout = T.output_place.timestamp
  return tin > tout
end
```

In an embodiment the constraint map management procedures are specified as:

```
Process a set of equations
translate_net(equations)
    net = new Net( )
    for each equation in equations
      net.add_equation(equation)
    end
    return net
end
Process an equation: left and right sides
Net.add_equation(equation)
  (var, tree) = parse_equation(equation)
  place = new Place(var)
  net.places.add(place)
  transition = new Transition(tree)
  net.transitions.add(transition)
  transition.output_place = place
  net.translate_tree(transition, tree)
  return transition.name
end
Process the right-side of an equation
Net.translate_tree(transition, node)
    if node.type == URI
    and node not in transition.input_places then
      place = net.places.find(node)
      if place = null then
          place = new Place(node)
          net.places.add(place)
      end
      transition.input_place.add(place)
    else
      for each child in node.children
          net.translate_tree(transition, child)
      end
    end
end
Net.delete_equation(eid)
    transition = net.find_transition(eid)
    if (transition != null) then
      net.places.remove(transition.output_place)
      net.transitions.remove(transition)
    end
end
```

In an embodiment, a constraint map server, such as constraint map server 130, 322, 352, or 522, may include a set of REST application programming interfaces (APIs) corresponding to the constraints applied to the resources within a cloud computing system. The following table lists the set of REST APIs:

TABLE 1
Constraint map Server REST API (Constraints)

| URI template | Request | Procedures | Response |
|---|---|---|---|
| /{controller}/constraints | POST | net = | 201 Created |
| | run_auto? | translate_net(equations) | /{controller/constraints/{cid} |
| | equations | Nets.add(net) | /{controller/constraints/{cid}/control |
| | | run_auto( ) | /{controller/constraints/{cid}/equations |
| | | | /{eid}+ |
| /{controller}/constraints/ | PUT | net=Nets.get(cid) | 200 OK |
| {cid}/control | run_auto\|stop | run_auto( )\|net.stop= | |
| | | true | |
| /{controller}/constraints | PUT | Nets.remove(cid) | 200 OK |
| /{cid} | equations | net = | /{controller/constraints/{cid}/equations |
| | | translate_net(equations) | /{eid}+ |
| | | Nets.add(net) | |
| /{controller}/constraints | GET | net=Nets.get(cid) | 200 OK |
| /{cid} | | | equations |
| | | | /{controller/constraints/{cid}/equations |
| | | | /{eid}+ |
| /{controller}/constraints | POST | net=Nets.get(cid) | 201 Created |
| /{cid} | equation | net.add_equation(equation) | /{controller/constraints/{cid}/equations |
| | | | /{eid} |
| /{controller}/constraints | DELETE | Nets.remove(cid) | 200 OK |
| /{cid} | | | |

In an embodiment, a constraint map server, such as constraint map server 130, 322, 352, or 522, may include a set of REST application programming interfaces (APIs) corresponding to the equations that define the relationship between the constraints applied to the resources within a cloud computing system. The following table lists the set of REST APIs:

TABLE 2
Constraint map Server REST API (Equations)

| URI template | Request | Procedures | Response |
|---|---|---|---|
| /{controller}/constraints/{cid}/equations/{eid} | GET | net=Nets.get(cid) | 200 OK |
| | | equation=net.get_equation(eid) | equation |
| /{controller}/constraints/{cid}/equations/{eid} | PUT | net=Nets.get(cid) | 200 OK |
| | equation | net.delete_equation(eid) | |
| | | net.add_equation(equation) | |
| /{controller}/constraints/{cid}/equations/{eid} | DELETE | net=Nets.get(cid) | 200 OK |
| | | net.delete_equation(eid) | |

In the preceding tables, {controller} may be defined as controller's URI to associate constraint maps with a REST controller, {cid} may be defined as constraint map id, and {eid} may be defined as constraint equation id within a constraint map. Although multiple constraint maps may be running at the same time at the server, each control variable is constrained by at most one constraint map to avoid control conflicts.

In various embodiments, a constraint equation in a REST API may be represented via the employment of Extensible Markup Language (XML) or JavaScript Object Notation (JSON). As an example, an infix equation “/cpu/cpushare=memory/memory.limit*2+/blkio/io.rate/5+/blkio/io.rate” may be represented by the W3C (World Wide Web Consortium) Content MathML (Mathematical Markup Language) 3.0 XML (http://www.w3.org/TR/MathML3/) as:

```
<math>
<apply><eq/>
<ci>“/cpu/cpushare”</ci>
  <apply>
    <plus/>
    <apply>
      <times/>
      <ci>“/memory/memory.limit”</ci>
      <cn>2</cn>
    </apply>
    <apply>
      <divide/>
      <ci>“/blkio/io.rate”</ci>
      <cn>5</cn>
    </apply>
    <ci>“/blkio/io.rate”</ci>
  </apply>
  </apply>
</math>
```

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A network element (NE) configured to implement a representational state transfer (REST) system, the NE comprising:
a receiver configured to:
receive a constraint from a REST client, wherein the constraint relates an independent control variable to a derived control variable, wherein the derived control variable is mapped to a first cloud computing resource employed by a cloud computing implementation; and
receive an independent value for the independent control variable from the REST client; and
a processor coupled to the receiver and configured to:
compute a derived value for the derived control variable based on the constraint and the independent value for the independent control variable; and
determine a first instruction regarding the first cloud computing resource based on the derived value.

2. The NE of claim 1 further configured to provide the first cloud computing resource to a recipient of the cloud computing implementation.

3. The NE of claim 1 further configured to implement a resource controller configured to control a plurality of first behaviors of the first cloud computing resource.

4. The NE of claim 3, wherein the resource controller alters one of the first behaviors of the first cloud computing resource based on the first instruction.

5. The NE of claim 4, wherein the resource controller is further configured to control a plurality of second behaviors of a second cloud computing resource employed by the cloud computing implementation.

6. The NE of claim 5, wherein the processor is further configured to determine a second instruction regarding a second cloud computing resource based on the independent value.

7. The NE of claim 6, wherein the resource controller alters one of the second behaviors of the second cloud computing resource based on the second instruction.

8. The NE of claim 1, further comprising a memory coupled to the processor, wherein the constraint is stored in the memory as an element of a constraint map, wherein the constraint map governs relationships between a set of cloud computing resources provisioned for the implementation by the NE, and wherein the set of cloud computing resources comprises the first cloud computing resource.

9. The NE of claim 8, wherein the set of cloud computing resources comprise network bandwidth, storage, and processing.

10. The NE of claim 8, wherein the constraint map is constructed by a mathematical modeling language.

11. The NE of claim 8, wherein the constraint map is a dual control constraint map that provides a language to define a plurality of constraints and a mechanism to apply the constraints to the set of cloud computing resources.

12. The NE of claim 1, wherein the constraint is defined as a mathematical function.

13. A method implemented in a network element (NE) configured to operate as a REST server, the method comprising:
receiving, through a receiver, a constraint from a REST client, wherein the constraint relates an independent control variable to a derived control variable, wherein the derived control variable is mapped to a first cloud computing resource employed by a cloud computing implementation;
receiving, through the receiver, an independent value for the independent control variable from the REST client;
computing, via a processor coupled to the receiver, a derived value for the derived control variable based on the constraint and the independent value for the independent control variable;
determining, via a processor, a first instruction regarding the first cloud computing resource based on the derived value; and
altering, via a resource controller coupled to the processor, one of a plurality of first behaviors of the first cloud computing resource based on the first instruction.

14. The method of claim 13, further comprising providing the first cloud computing resource to a recipient of the cloud computing implementation.

15. The method of claim 13, further comprising:
determining, via a processor, a second instruction regarding a second cloud computing resource employed by the cloud computing implementation based on the independent value; and
altering, via the resource controller coupled to the processor, one of a plurality of second behaviors of a second cloud computing resource based on the second instruction, wherein the second cloud computing resource is employed by the cloud computing implementation.

16. The method of claim 15, further comprising storing, in a memory coupled to the processor, the constraint as an element of a constraint map, wherein the constraint map governs relationships between a set of cloud computing resources provisioned for the implementation by the NE, and wherein the set of cloud computing resources comprises the first cloud computing resource and the second cloud computing resource.

17. A computer program product comprising computer executable instructions stored on a non-transitory computer readable medium such that when executed by a processor cause a network element (NE) to:
receive, through a receiver, an independent value for an independent control variable;
compute, via a processor, a derived value for a derived control variable based on a constraint and the independent value for the independent control variable, wherein the constraint relates the independent control variable to the derived control variable, wherein the derived control variable is mapped to a first cloud computing resource, wherein the first cloud computing resource is employed by a cloud computing implementation and provided to a recipient of the cloud computing implementation; and
forward, through a transmitter coupled to the receiver, the derived value to a REST server implemented on another NE.

18. The computer program product of claim 17, further comprising storing, in a memory coupled to the processor, the constraint as an element of a constraint map, wherein the constraint map governs relationships between a set of cloud computing resources provisioned for the implementation by the other NE, and wherein the set of cloud computing resources comprises the first cloud computing resource.

19. The computer program product of claim 18, wherein the constraint map is constructed by a mathematical modeling language.

20. The computer program product of claim 17, wherein the constraint is represented with Extensible Markup Language (XML).
